(19) United States
(12) Patent Application Publication
(10) Pub. No.: US 2019/0019207 A1
(43) Pub. Date: Jan. 17, 2019

(54) APPARATUS AND METHOD FOR STORE ANALYSIS

(71) Applicant: SAMSUNG SDS CO., LTD., Seoul (KR)

(72) Inventors: Ji-Young CHOI, Seoul (KR); Hyun-Suk JUNG, Seoul (KR); Joo-Young JANG, Seoul (KR); Hyun-Ji DO, Seoul (KR); Su-Ky JUNG, Seoul (KR); Yong-Guk PARK, Seoul (KR); Min-Soon KIM, Seoul (KR); Eun-Ki JUNG, Seoul (KR); Dong-Sik KANG, Seoul (KR)

(73) Assignee: SAMSUNG SDS CO., LTD., Seoul (KR)

(21) Appl. No.: 16/034,619

(22) Filed: Jul. 13, 2018

(30) Foreign Application Priority Data
Jul. 13, 2017 (KR) 10-2017-0088977

(51) Int. Cl. G06Q 30/02; G06K 9/00

(52) U.S. Cl. CPC G06Q 30/0205; H04N 7/181; G06K 9/00778

(57) ABSTRACT

An apparatus and method for store analysis are provided. According to the embodiments of the present disclosure, customer congestion, sales information and a degree of correlation between the ROIs are analyzed for each of the ROIs of a user in a store, so that it is possible to provide information for optimizing locations of products displayed in the store, thereby making it possible to increase the sales of the store.

### CROSS-REFERENCE TO RELATED APPLICATION(S)

This application claims the benefit under 35 USC § 119(a) of Korean Patent Application No. 10-2017-0088977, filed on Jul. 13, 2017, in the Korean Intellectual Property Office, the entire disclosure of which is incorporated herein by reference for all purposes.

### BACKGROUND

### 1. Field

The following description relates to a technology for analyzing visitors and sales in a store.

### 2. Description of Related Art

Various analytical methods are used to increase the sales of stores through customer analysis and sales analysis in various types of stores that sell products, such as department stores, superstores, and convenience stores.

However, conventional analytical methods simply analyze the tendency of customers or analyze the sales pattern, so that it is difficult to determine whether products in the store are displayed at appropriate positions.

Accordingly, there is a growing demand for an analysis technology for optimizing display positions of products in the store for sales increase.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide an apparatus and method for analyzing visitors and sales in a store.

In one general aspect, there is provided, an apparatus for store analysis, comprising: an image acquirer configured to acquire an image captured by each of a plurality of cameras disposed in a store; an image analyzer configured to identify a visitor in each of the acquired images and generate visitor information which includes a point in time at which the visitor is identified in each of the acquired images; a storage configured to store product location information of products in the store, camera location information of each of the plurality of cameras, and the visitor information; an analysis condition determiner configured to receive an analysis condition which includes one or more regions of interest (ROIs) in the store and an analysis target period; a congestion analyzer configured to generate ROI-specific congestion information for the analysis target period using the camera location information and the visitor information; and a sales analyzer configured to generate sales information of each of the ROIs for the analysis target period using the product location information and in-store product sales information about products sold in the store.

The ROI-specific congestion information may comprise a number of visitors in each of the ROIs during the analysis target period.

The apparatus for store analysis may further comprise a correlation analyzer configured to calculate a degree of correlation between the ROIs using a pattern of change in the number of visitors in each of the ROIs during the analysis target period.

The visitor information may further comprise dwell time of the visitor identified in each of the acquired images and the ROI-specific congestion information may comprise average dwell time of visitors in each of the ROIs during the analysis target period.

The congestion analyzer may be further configured to identify one or more cameras disposed in each of the ROIs among the plurality of cameras using of the camera location information, and generate the ROI-specific congestion information using the visitor information associated with the identified one or more cameras.

The sales information of each of the ROIs may comprise at least one from among product sales quantity and product sales amount of products sold in each of the ROIs in the analysis target period.

The sales analyzer may be further configured to identify products displayed in each of the ROIs using the product location information, and extract product sales information of the identified products sold in the analysis target period from the in-store product sales information to generate the sales information of each of the ROIs.

The analysis condition may further comprise a comparison target period and the sales information of each of the ROIs may further comprise a rate of change in sales quantity or sales amount of products sold in each of the ROIs in the analysis target period relative to the comparison target period.

The sales analyzer may be further configured to identify products displayed in each of the ROIs using the product location information, and extract product sales information of the identified products sold in the analysis target period and in the comparison target period from the in-store product sales information to calculate the rate of change.

The apparatus may further comprise an analysis report generator configured to generate an analysis report based on at least one from among the ROI-specific congestion information, the degree of correlation, and the sales information of each of the ROIs.

The analysis report may visually display at least one from among the ROI-specific congestion information, the degree of correlation between the ROIs, and the sales information of each of the ROIs.

The analysis report may comprise at least one from among a promotion offer and a suggestion on product relocation based on at least one from among the ROI-specific congestion information, the degree of correlation between the ROIs, and the sales information of each of the ROIs.

In another general aspect, there is provided a method for store analysis, comprising: acquiring an image captured by each of a plurality of cameras disposed in a store; identifying a visitor in each of the acquired images and generating visitor information which includes a point in time at which the visitor is identified in each of the acquired image; receiving an analysis condition which includes one or more regions of interest (ROIs) in the store and an analysis target period from a user; generating ROI-specific congestion information for the analysis target period using camera location information of each of the plurality of cameras and the visitor information; and generating sales information of each of the ROIs for the analysis target period using the product location information and in-store product sales information about products sold in the store.

The ROI-specific congestion information may comprise a number of visitors in each of the ROIs during the analysis target period.

The method for store analysis may further comprise calculating a degree of correlation between the ROIs using using a pattern of change in the number of visitors in each of the ROIs during the analysis target period.

The visitor information may further comprise dwell time of the visitor identified in each of the acquired images and the ROI-specific congestion information may comprise average dwell time of visitors in each of the ROIs during the analysis target period.

The generating of the ROI-specific congestion information may comprise identifying one or more cameras disposed in each of the ROIs among the plurality of cameras using the camera location information and generating the ROI-specific congestion information using the visitor information associated with the identified one or more cameras.

The sales information of each of the ROIs may comprise at least one from among product sales quantity and product sales amount of products sold in each of the ROIs in the analysis target period.

The generating of the sales information of each of the ROIs may comprise identifying products displayed in each of the ROIs using the product location information and extracting product sales information of the identified products sold in the analysis target period from the in-store product sales information to generate the sales information of each of the ROIs.

The analysis condition may further comprise a comparison target period and the sales information of each of the ROIs may further comprise a rate of change in sales quantity or sales amount of products sold in each of the ROIs in the analysis target period relative to the comparison target period.

The generating of the sales information of each of the ROIs may comprise identifying products displayed in each of the ROIs using the product location information and extracting product sales information of the identified products sold in the analysis target period and in the comparison target period from the in-store product sales information to calculate the rate of change.

The method may further comprise generating an analysis report based on at least one from among the ROI-specific congestion information, the degree of correlation, and the sales information of each of the ROIs.

The analysis report may visually display at least one from among the ROI-specific congestion information, the degree of correlation between the ROIs, and the sales information of each of the ROIs.

The analysis report may comprise at least one from among a promotion offer and a suggestion on product relocation based on at least one from among the ROI-specific congestion information, the degree of correlation between the ROIs, and the sales information of each of the ROIs.

Other features and aspects will be apparent from the following detailed description, the drawings, and the claims.

### BRIEF DESCRIPTION OF THE DRAWINGS

FIG. 1 is a configuration diagram illustrating an apparatus for store analysis according to one embodiment of the present disclosure.

FIG. 2 is a diagram illustrating an example of an analysis report.

FIG. 3 is a diagram illustrating another example of the analysis report.

FIG. 4 is a diagram illustrating still another example of the analysis report.

FIG. 5 is a flowchart illustrating a method for store analysis according to another example of the present disclosure.

FIG. 6 is a block diagram for describing a computing environment including a computing device suitable for use in illustrative embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

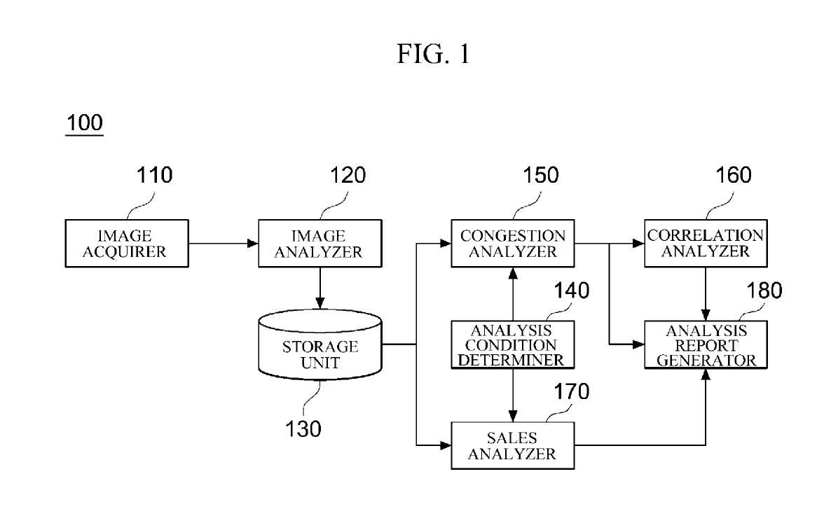

FIG. 1 is a configuration diagram illustrating an apparatus 100 for store analysis according to one embodiment of the present disclosure.

Referring to FIG. 1, the apparatus 100 for store analysis according to one embodiment of the present disclosure includes an image acquirer 110, an image analyzer 120, a storage unit 130, an analysis condition determiner 140, a congestion analyzer 150, a correlation analyzer 160, a sales analyzer 170, and an analysis report generator 180.

The image acquirer 110 acquires images from each of a plurality of cameras installed in a store. In this case, the plurality of cameras may be disposed at different positions in the store and each of the cameras may continuously capture images of a different area to generate an image of the pertinent area.

Meanwhile, the images captured by each of the cameras installed in the store may be directly acquired from the cameras through a wired/wireless network, or may be acquired from a separate database in which the images captured by each of the cameras are stored.

The image analyzer 120 identifies a visitor in the images captured by each of the cameras and generates visitor information which includes a point in time at which the visitor is identified in each of the images. In this case, the image analyzer 120 may identify the visitor in the images captured by each of the cameras using, for example, various known object recognition and tracking techniques.

Meanwhile, according to one embodiment of the present disclosure, the visitor information may further include dwell time of the visitor identified in each of the images. Specifically, when the image analyzer 120 identifies a visitor in the images captured by each of the cameras, the image analyzer 120 may calculate dwell time by tracking the identified visitor. For example, the image analyzer 120 may calculate the dwell time of each of the visitors by calculating a period of time from the point in time at which each visitor is identified in each of the images to a point in time at which the visitor disappears in each of the images.

In-store product location information, camera position information of each of the cameras installed in the store, and the visitor information generated by the image analyzer 120 are stored in the storage unit 130.

In this case, the product location information may include, for example, identification information and display position of each product displayed in the store. In addition, the camera location information may include, for example, identification information and location of each camera disposed in the store.

According to one embodiment of the present disclosure, the product location information and the camera location information may be stored in association with a static map of the store. For example, the display position of each product and the disposition location of each camera may be stored as locations on the static map of the store.

The visitor information generated from the image captured by each of the cameras may be stored in association with the identification information of the corresponding camera.

The analysis condition determiner 140 receives an analysis condition including at least one region of interest (ROI) in the store and an analysis target period, which is set by a user.

Specifically, the analysis condition determiner 140 may provide, for example, a user interface screen for receiving the analysis condition from the user and then receive at least one ROI, which has been set through the user interface screen, from a user terminal. For example, the analysis condition determiner 140 may provide the user interface screen on which the static map of the store is displayed to the user terminal and the user may select at least one ROI from the static map displayed on a display screen mounted in the user terminal using, for example, an input means provided in the user terminal, such as a mouse, a keyboard, and the like.

Meanwhile, according to an embodiment, the analysis condition may further include a comparison target period.

The congestion analyzer 150 generate congestion information of each of the ROIs for the analysis target period on the basis of the analysis condition set by the user, and the camera location information and the visitor information which are stored in the storage unit 130.

Specifically, the congestion analyzer 150 may identify the camera disposed in each of the ROIs set by the user on the basis of the camera location information. For example, as described above, the camera location information of each camera may be stored as a location on the static map of the store and each of the ROIs may be set as a region on the static map of the store. Accordingly, the congestion analyzer 150 may compare each ROI and the location of each camera on the static map of the store, thereby identifying the camera disposed in each of the ROIs. In this case, one or more cameras may be disposed in each of the ROIs according to settings of the user for the ROIs.

Meanwhile, when the cameras disposed in each of the ROIs are identified, the congestion analyzer 150 may generate ROI-specific congestion information using the visitor information associated with the identified cameras.

Specifically, according to one embodiment of the present disclosure, the ROI-specific congestion information may include the number of visitors in each of the ROIs during the analysis target period, which is input as the analysis condition. For example, the congestion analyzer 150 may count the number of visitors identified within the analysis target period from the visitor information associated with the camera disposed in each of the ROIs, thereby calculating the number of visitors in each of the ROIs. In this case, when a plurality of cameras are disposed in a particular ROI, the number of visitors identified within the analysis target period are counted from each piece of visitor information associated with the respective cameras and the counts are added together, thereby calculating the number of visitors of the particular ROI.

According to one embodiment of the present disclosure, the ROI-specific congestion information may include average dwell time of visitors in each of the ROIs during the analysis target period, which is input as the analysis condition. For example, the congestion analyzer 150 may extract dwell time of each of the visitors identified within the analysis target period from the visitor information associated with the camera disposed in each of the ROIs and calculate the average thereof, thereby calculating the average dwell time of the visitors in each of the ROIs. Meanwhile, when a plurality of cameras are disposed in each of the ROIs, dwell time of each of the visitors identified within the analysis target period is extracted from the visitor information associated with each camera and an average thereof is calculated so that the average dwell time of the visitors in the corresponding ROI can be calculated.

The correlation analyzer 160 calculates a degree of correlation between the ROIs based on the ROI-specific congestion information generated by the congestion analyzer 150.

Specifically, according to one embodiment of the present disclosure, the correlation analyzer 160 may calculate a degree of correlation between the ROIs on the basis of a pattern of change in the number of visitors in each of the ROIs during the analysis target period. For example, the correlation analyzer 160 may calculate the degree of correlation between the ROIs such that the degree of correlation increases as the temporal patterns of change in the number of visitors in two ROIs during the analysis target period are more similar to each other.

As a more specific example, the degree of correlation between the ROIs may have a value between −1 and 1. In this case, as the patterns of change in the number of visitors in two ROIs during the target analysis period are more similar to each other, the degree of correlation between the two ROIs may become closer to 1. On the other hand, as the patterns of change in the number of visitors in two ROIs during the analysis target period are opposite to each other, the degree of correlation between the two ROIs may become closer to −1.

The sales analyzer 170 generates sales information of each of the ROIs for the analysis target period on the basis of the in-store product sales information and the product location information stored in the storage unit 130.

In this case, the in-store product sales information may be obtained from, for example, a point of sale (POS) system of the store and may include identification information, category, time point of sale, sales quantity, sales amount, or the like of items sold in the store.

More specifically, the sales analyzer 170 may identify products displayed in each of the ROIs on the basis of the product location information. In addition, the sales analyzer 170 may extract the product sales information of products displayed in each of the ROIs and sold in the analysis target period from the in-store product sales information and generate the sales information of each of the ROIs for the analysis target period. In this case, the sales information of each of the ROIs for the analysis target period may include at least one of a product category, product sales quantity, and product sales amount.

Meanwhile, according to one embodiment of the present disclosure, when the user has set the analysis target period and the comparison target period, the sales information of each of the ROIs, which is generated by the sales analyzer 170, may include a rate of change in sales quantity or sales amount of products sold in each of the ROIs in the analysis target period relative to the comparison target period. Specifically, the sales analyzer 170 may extract product sales information of products displayed in each of the ROIs and sold in the comparison target period and the product sales information of the same products sold in the analysis target period from the in-store product sales information, and then compare the two pieces of product sales information to calculate the rate of change in sales quantity or sales amount of products sold in each of the ROIs in the analysis target period relative to the comparison target period.

The analysis report generator 180 generates an analysis report on the basis of at least one of the ROI-specific congestion information, the degree of correlation between the ROIs, and the sales information of each of the ROIs.

In this case, according to one embodiment of the present disclosure, the analysis report generator 180 may generate the analysis report on the basis of at least one of the ROI-specific congestion information, the degree of correlation between the ROIs, and the sales information of each of the ROIs according to the user's request, and then provide the analysis report to the user terminal.

Meanwhile, according to one embodiment of the present disclosure, the analysis report may, for example, visually display at least one of the ROI-specific congestion information, the degree of correlation between the ROIs, and the sales information of each of the ROIs.

In addition, according to one embodiment of the present disclosure, the analysis report may include, for example, at least one of a promotion offer and a suggestion on product relocation based on at least one of the ROI-specific congestion information, the degree of correlation between the ROIs, and the sales information of each of the ROIs.

For example, the analysis report generator 180 may identify a time period during which the numbers of visitors increase simultaneously in the ROIs whose degree of correlation is greater than or equal to a predetermined reference value, and then generate a promotion offer, such as a discount of a bundle of products during the identified time period, wherein the products disposed in the corresponding ROIs are grouped as the bundle.

In another example, when the product sales quantity or the product sales amount of products disposed and sold in a particular ROI among the ROIs whose degree of correlation is greater than or equal to a predetermined reference value increases while the product sales quantity or the product sales amount of the products disposed and sold in the other ROIs does not increase or decreases, the analysis report generator 180 may generate a promotion offer, such as a discount, issuance of coupons, provision of a free gift, or the like, for the products disposed in the ROIs in which the product sales quantity or the product sales amount does not increase or decreases.

Also, in another example, when the ROIs whose degree of correlation is greater than or equal to a predetermined reference value are not close to each other in the store, the analysis report generator 180 may provide a suggestion on product relocation such that the products disposed in the corresponding ROIs are located in near regions.

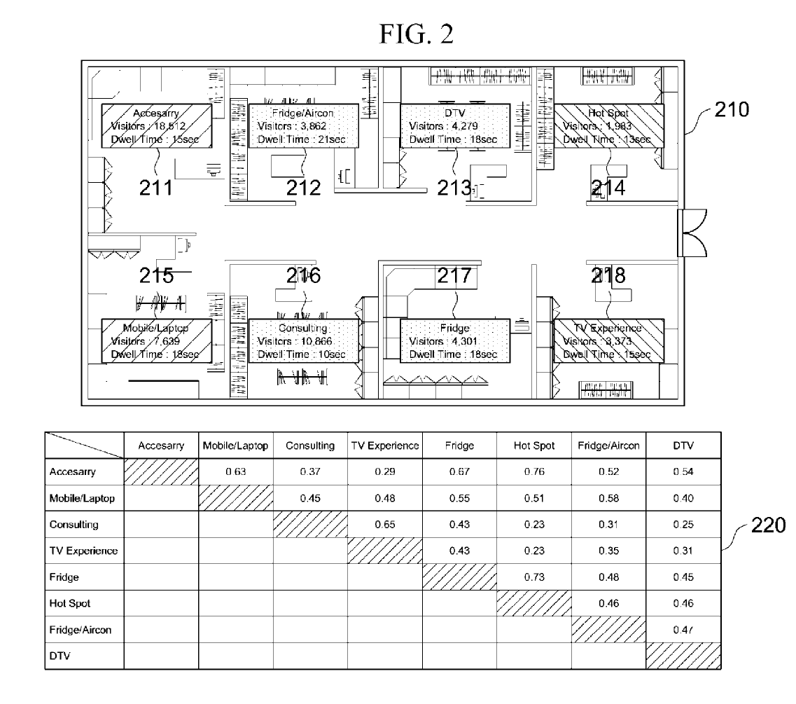

FIG. 2 is a diagram illustrating an example of an analysis report.

Specifically, FIG. 2 illustrates an example of an analysis report for a degree of correlation between ROI-specific congestion information and ROIs. As shown in FIG. 2, the analysis report may display each of the ROIs 211 to 218 set by the user on a static map 210 of the store. In addition, in each of the ROIs 211 to 218 displayed on the static map 210 of the store, a category of displayed products, the number of visitors, and average dwell time of the visitors may be displayed.

A degree of correlation among the ROIs 211 to 218 may be displayed by, for example, colors of the ROIs 211 to 218 displayed on the static map of the store. Specifically, when the user selects the ROI 211 in which accessories are displayed from the ROIs 211 to 218 displayed on the analysis report, each of the non-selected ROIs 212 to 218 may be represented by different colors according to the degree of correlation between the selected ROI 211 and each of the other ROIs 212 to 218.

In addition, the degree of correlation among the ROIs 211 to 218 may be expressed in the form of a correlation table 220 that numerically represents the degrees of correlation.

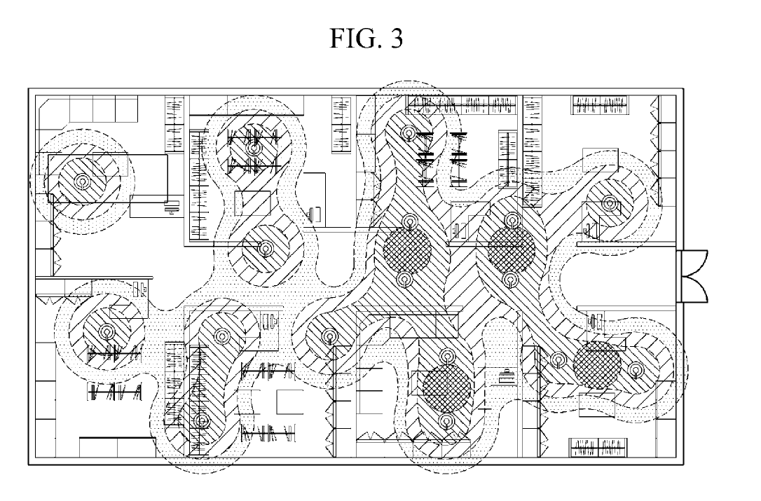

FIG. 3 is a diagram illustrating another example of the analysis report.

Specifically, FIG. 3 illustrates one example of an analysis report for the ROI-specific congestion information. As shown in FIG. 3, the analysis report may display the ROI-specific congestion information in the form of a heat map. In this case, on the basis of the number of visitors in each of the ROIs, the heat map may represent a region having a relatively large number of visitors in red and a region having a relatively small number of visitors in green.

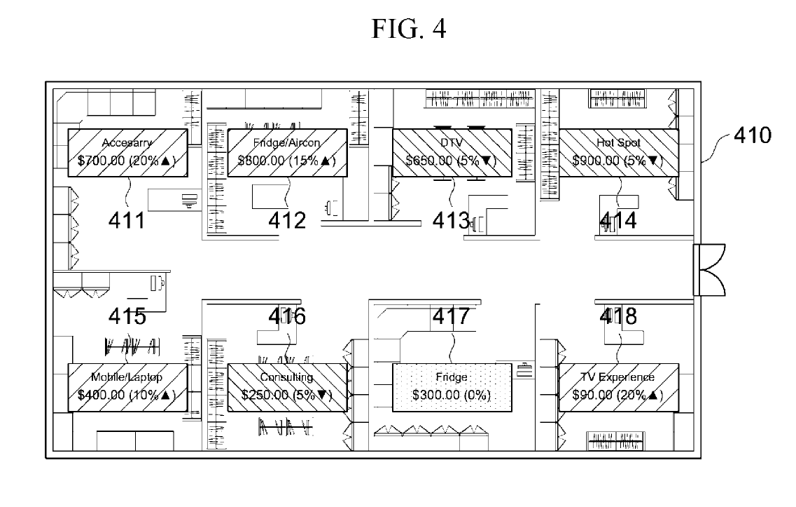

FIG. 4 is a diagram illustrating still another example of the analysis report.

Specifically, FIG. 4 illustrates one example of an analysis report for sales information of each ROI. As shown in FIG. 4, the analysis report may display ROIs 411 to 418 set by the user on a static map 410 of the store. In addition, as shown in FIG. 4, in each of the ROIs 411 to 418 displayed on the static map of the store, a category, sales amount, sales quantity, and the like of products displayed in each of the ROIs may be displayed.

In addition, when the user has set an analysis target period and a comparison target period, a rate of change in product sales quantity or product sales amount of products sold in the analysis target period relative to the comparison target period may be displayed in each of the ROIs 411 to 418 displayed on the static map of the store. In this case, the rate of change may be represented by a number within each of the ROIs 411 to 418 as shown in the illustrated example. Further, the rate of change may be represented by colors of each of the ROIs 411 to 418. For example, a region in which the product sales amount or the product sales quantity increases, among the ROIs 411 to 418, may be represented in red and a region in which the product sales amount or the product sales quantity decreases may be represented in blue.

Meanwhile, the analysis report generated by the analysis report generator 180 may be generated in various forms in addition to the examples illustrated in FIGS. 2 to 4 according to an embodiment.

In one embodiment, the image acquirer 110, the image analyzer 120, the storage unit 130, the analysis condition determiner 140, the congestion analyzer 150, the correlation analyzer 160, the sales analyzer 170, and the analysis report generator 180, which are illustrated in FIG. 1, may be implemented on one or more computing devices each of which includes one or more processors and a computer-readable recording medium connected to the one or more processors. The computer-readable recording medium may be inside or outside of the processors and may be connected to the processors by various well-known means. The processors in the computing device may cause each computing device to operate in accordance with the illustrative embodiments described in the present disclosure. For example, the processor may execute an instruction stored in the computer-readable recording medium and the instruction stored in the computer-readable recording medium may, when executed by the processor, cause the computing device to perform operations in accordance with the illustrative embodiments.

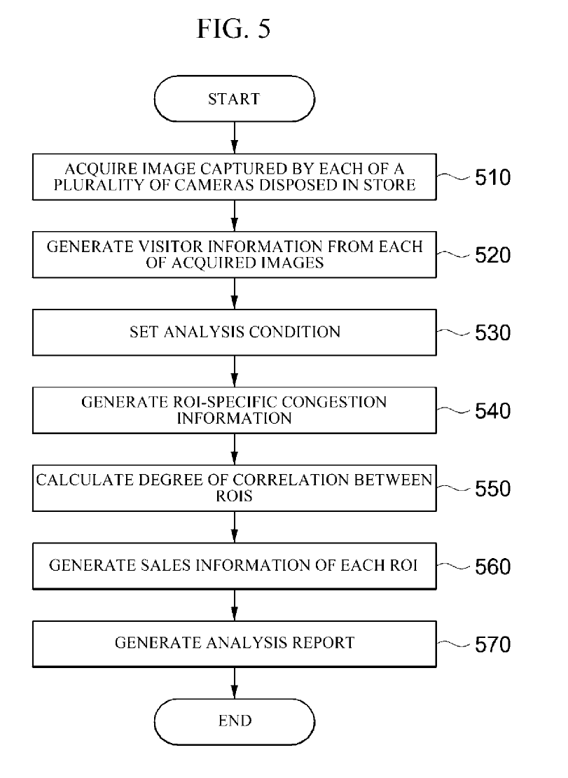

FIG. 5 is a flowchart illustrating a method for store analysis according to another example of the present disclosure.

The method illustrated in FIG. 5 may be performed by the apparatus 100 for store analysis illustrated in FIG. 1.

Referring to FIG. 5, in 510, the apparatus 100 for store analysis acquires images captured by each of the cameras disposed in the store.

Then, in 520, the apparatus 100 identifies a visitor in each of the acquired images and generates visitor information which includes a point in time at which the visitor is identified in each of the images.

In this case, according to an embodiment, the visitor information may further include dwell time of the visitor identified in each of the images.

Then, the apparatus 100 receives an analysis condition including one or more ROIs in the store and an analysis target period, which is set by the user in 530.

Then, in 540, the apparatus 100 generates ROI-specific congestion information for the analysis target period on the basis of camera location information of each of a plurality of cameras and visitor information.

Specifically, according to one embodiment of the present disclosure, the apparatus 100 may identify one or more cameras disposed in each of the ROIs among the plurality of cameras on the basis of the camera location information and generate the ROI-specific congestion information using the visitor information associated with the identified camera.

In addition, according to one embodiment of the present disclosure, the ROI-specific congestion information may further include the number of visitors in each of the ROIs during the analysis target period.

Moreover, according to one embodiment of the present disclosure, the ROI-specific congestion information may include average dwell time of visitors in each of the ROIs during the analysis target period.

Then, in 550, the apparatus 100 calculates a degree of correlation between the ROIs on the basis of the generated ROI-specific congestion information.

In this case, according to one embodiment of the present disclosure, the apparatus 100 may calculate a degree of correlation between the ROIs on the basis of a pattern of change in the number of visitors in each of the ROIs during the analysis target period.

Thereafter, in 560, the apparatus 100 generates sales information of each of the ROIs for the analysis target period on the basis of product location information of the products in the store and in-store product sales information.

According to one embodiment of the present disclosure, the sales information of each of the ROIs may include at least one of product sales quantity and product sales amount of products sold in each of the ROIs in the analysis target period. In this case, according to one embodiment of the present disclosure, the apparatus 100 may identify products displayed in each of the ROIs on the basis of the product location information and extract the product sales information of identified products sold in the analysis target period from the in-store product sales information to generate the sales information of each of the ROIs.

In addition, according to one embodiment of the present disclosure, the sales information of each of the ROIs may further include a rate of change in sales quantity or sales amount of products sold in each of the ROIs in the analysis target period relative to the comparison target period. In this case, according to one embodiment of the present disclosure, the apparatus 100 may identify the products displayed in each of the ROIs on the basis of the product location information and extract the product sales information of the identified products sold in the analysis target period and in the comparison target period from the in-store product sales information to calculate the rate of change.

Then, in 570, the apparatus 100 generates an analysis report based on at least one of the ROI-specific congestion information, the degree of correlation between the ROIs, and the sales information of each of the ROIs.

In this case, according to one embodiment of the present disclosure, the analysis report may, for example, visually display at least one of the ROI-specific congestion information, the degree of correlation between the ROIs, and the sales information of each of the ROIs.

In addition, according to one embodiment of the present disclosure, the analysis report may include, for example, at least one of a promotion offer and a suggestion on product relocation based on at least one of the ROI-specific congestion information, the degree of correlation between the ROIs, and the sales information of each of the ROIs.

Meanwhile, in the flowchart illustrated in FIG. 5, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added and performed.

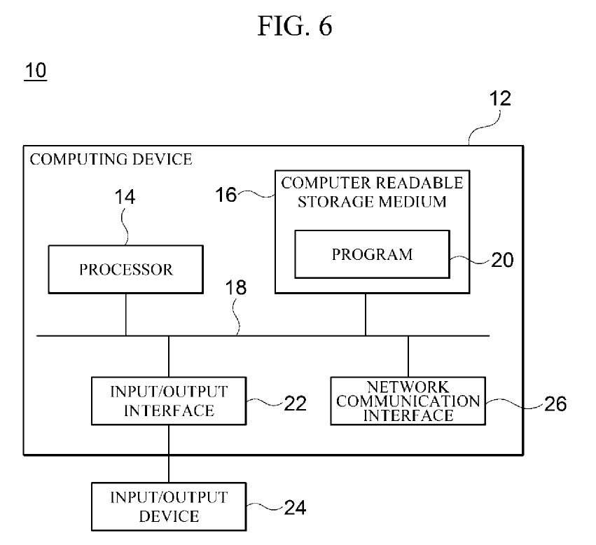

FIG. 6 is a block diagram for describing a computing environment including a computing device suitable for use in illustrative embodiments. In illustrated embodiment, components each may provide different functions and capabilities as well as the functions and capabilities described herein, and extra components may be included in addition to those described below.

The illustrated computing environment 10 includes a computing device 12. In one embodiment, the computing device 12 may be one or more components, such as the image acquirer 110, the image analyzer 120, the storage unit 130, the analysis condition determiner 140, the congestion analyzer 150, the correlation analyzer 160, the sales analyzer 170, and the analysis report generator 180, which are included in the apparatus 100 for store analysis shown in FIG. 1.

The computing device 12 includes at least one processor 14, a computer-readable storage medium 16, and a communication bus 18. The processor 14 may cause the computing device 12 to operate in accordance with the aforementioned illustrative embodiments. For example, the processor 14 may execute one or more programs 20 stored in the computer-readable storage medium 16. The one or more programs may include one or more computer-executable instructions, which, when executed by the processor 14, cause the computing device 12 to perform operations in accordance with the illustrative embodiments.

The computer-readable storage medium 16 is configured to store computer-executable instructions, program code, program data, and/or other suitable forms of information. The program 20 stored in the computer-readable storage medium 16 includes a set of instructions executable by the processor 14. In one embodiment, the computer-readable storage medium 16 may be memory (volatile memory, such as random access memory (RAM), non-volatile memory, or any suitable combination thereof), one or more magnetic disc storage devices, optical disk storage devices, flash memory devices, and other forms of storage media accessible by the computing device 12 and capable of storing desired information, or any suitable combination thereof.

The communication bus 18 interconnects other components of the computing device 12 including the processor 14 and the computer-readable storage medium 16.

The computing device 12 may include one or more input/output interfaces 22 configured to provide interfaces for one or more input/output devices, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (a mouse, a trackpad, or the like), a keyboard, a touch input device (a touchpad, a touch screen, or the like), a voice or sound input device, an input device, such as a variety of sensor devices and/or an image capturing device, and/or an output device, such as a display device, a printer, a speaker and/or a network card. The exemplary input/output device 24 may be included in the computing device 12 as one component constituting the computing device 12, or may be connected to the computing device 12 as an independent device separate from the computing device 12.

According to the embodiments of the present disclosure, customer congestion, sales information and a degree of correlation between the ROIs are analyzed for each of the ROIs of a user in a store, so that it is possible to provide information for optimizing locations of products displayed in the store, thereby making it possible to increase the sales of the store.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for store analysis, comprising:
an image acquirer configured to acquire an image captured by each of a plurality of cameras disposed in a store;
an image analyzer configured to identify a visitor in each of the acquired images and generate visitor information which includes a point in time at which the visitor is identified in each of the acquired images;
a storage configured to store product location information of products in the store, camera location information of each of the plurality of cameras, and the visitor information;
an analysis condition determiner configured to receive an analysis condition which includes one or more regions of interest (ROIs) in the store and an analysis target period;
a congestion analyzer configured to generate ROI-specific congestion information for the analysis target period using the camera location information and the visitor information; and
a sales analyzer configured to generate sales information of each of the ROIs for the analysis target period using the product location information and in-store product sales information about products sold in the store.

2. The apparatus of claim 1, wherein the ROI-specific congestion information comprises a number of visitors in each of the ROIs during the analysis target period.

3. The apparatus of claim 2, further comprising:
a correlation analyzer configured to calculate a degree of correlation between the ROIs using a pattern of change in the number of visitors in each of the ROIs during the analysis target period.

4. The apparatus of claim 1, wherein:
the visitor information further comprises dwell time of the visitor identified in each of the acquired images; and
the ROI-specific congestion information comprises average dwell time of visitors in each of the ROIs during the analysis target period.

5. The apparatus of claim 1, wherein the congestion analyzer is further configured to identify one or more cameras disposed in each of the ROIs among the plurality of cameras using the camera location information, and generate the ROI-specific congestion information using the visitor information associated with the identified one or more cameras.

6. The apparatus of claim 1, wherein the sales information of each of the ROIs comprises at least one from among product sales quantity and product sales amount of products sold in each of the ROIs in the analysis target period.

7. The apparatus of claim 1, wherein the sales analyzer is further configured to identify products displayed in each of the ROIs using the product location information, and extract product sales information of the identified products sold in the analysis target period from the in-store product sales information to generate the sales information of each of the ROIs.

8. The apparatus of claim 1, wherein:
the analysis condition further comprises a comparison target period; and
the sales information of each of the ROIs further comprises a rate of change in sales quantity or sales amount of products sold in each of the ROIs in the analysis target period relative to the comparison target period.

9. The apparatus of claim 8, wherein the sales analyzer is further configured to identify products displayed in each of the ROIs using the product location information, and extract product sales information of the identified products sold in the analysis target period and in the comparison target period from the in-store product sales information to calculate the rate of change.

10. The apparatus of claim 3, further comprising an analysis report generator configured to generate an analysis report based on at least one from among the ROI-specific congestion information, the degree of correlation, and the sales information of each of the ROIs.

11. The apparatus of claim 10, wherein the analysis report visually displays at least one from among the ROI-specific congestion information, the degree of correlation between the ROIs, and the sales information of each of the ROIs.

12. The apparatus of claim 10, wherein the analysis report comprises at least one from among a promotion offer and a suggestion on product relocation based on at least one from among the ROI-specific congestion information, the degree of correlation between the ROIs, and the sales information of each of the ROIs.

13. A method for store analysis, comprising:
acquiring an image captured by each of a plurality of cameras disposed in a store;
identifying a visitor in each of the acquired images and generating visitor information which includes a point in time at which the visitor is identified in each of the acquired image;
receiving an analysis condition which includes one or more regions of interest (ROI) in the store and an analysis target period from a user;
generating ROI-specific congestion information for the analysis target period using camera location information of each of the plurality of cameras and the visitor information; and
generating sales information of each of the ROIs for the analysis target period using product location information and in-store product sales information about products sold in the store.

14. The method of claim 13, wherein the ROI-specific congestion information comprises a number of visitors in each of the ROIs during the analysis target period.

15. The method of claim 14, further comprising:
calculating a degree of correlation between the ROIs using a pattern of change in the number of visitors in each of the ROIs during the analysis target period.

16. The method of claim 13, wherein:
the visitor information further comprises dwell time of the visitor identified in each of the acquired images; and
the ROI-specific congestion information comprises average dwell time of visitors in each of the ROIs during the analysis target period.

17. The method of claim 13, wherein the generating of the ROI-specific congestion information comprises identifying one or more cameras disposed in each of the ROIs among the plurality of cameras using the camera location information and generating the ROI-specific congestion information using the visitor information associated with the identified one or more cameras.

18. The method of claim 13, wherein the sales information of each of the ROIs comprises at least one from among product sales quantity and product sales amount of products sold in each of the ROIs in the analysis target period.

19. The method of claim 13, wherein the generating of the sales information of each of the ROIs comprises identifying products displayed in each of the ROIs using the product location information and extracting product sales information of the identified products sold in the analysis target period from the in-store product sales information to generate the sales information of each of the ROIs.

20. The method of claim 13, wherein:
the analysis condition further comprises a comparison target period; and
the sales information of each of the ROIs further comprises a rate of change in sales quantity or sales amount of products sold in each of the ROIs in the analysis target period relative to the comparison target period.

21. The method of claim 20, wherein the generating of the sales information of each of the ROIs comprises identifying products displayed in each of the ROIs using the product location information and extracting product sales information of the identified products sold in the analysis target period and in the comparison target period from the in-store product sales information to calculate the rate of change.

22. The method of claim 15, further comprising generating an analysis report based on at least one from among the ROI-specific congestion information, the degree of correlation, and the sales information of each of the ROIs.

23. The method of claim 22, wherein the analysis report visually displays at least one from among the ROI-specific congestion information, the degree of correlation between the ROIs, and the sales information of each of the ROIs.

24. The method of claim 22, wherein the analysis report comprises at least one from among a promotion offer and a suggestion on product relocation based on at least one from among the ROI-specific congestion information, the degree of correlation between the ROIs, and the sales information of each of the ROIs.
